(19) United States
(12) Patent Application Publication
(10) Pub. No.: US 2026/0113146 A1
(43) Pub. Date: Apr. 23, 2026

(54) PROBABILISTIC SHAPING THROUGH ASYMMETRIC NUMERAL SYSTEMS

(71) Applicant: QUALCOMM Incorporated, San Diego, CA (US)

(72) Inventors: Wei YANG, San Diego, CA (US); Jing JIANG, San Diego, CA (US)

(21) Appl. No.: 18/921,288

(22) Filed: Oct. 21, 2024

(51) Int. Cl. H04L 1/00; H04L 5/00; H04L 27/34

(52) U.S. Cl. CPC H04L 1/0042; H04L 5/0053; H04L 27/3405

(57) ABSTRACT

Certain aspects of the present disclosure provide techniques for receiving a communication; decoding the communication to obtain a symbol sequence that is associated with a non-uniform probabilistic shaping distribution; performing a plurality of operations of asymmetric numeral system (ANS) encoding on a reverse symbol sequence derived from the symbol sequence, wherein a first operation of the plurality of operations uses a first probability parameter and a first symbol of the reverse symbol sequence, and wherein a second operation of the plurality of operations uses a second probability parameter and a second symbol of the reverse symbol sequence that occurs after the first symbol of the reverse symbol sequence; and obtaining a binary sequence in accordance with the ANS encoding.

### INTRODUCTION

### Field of the Disclosure

Aspects of the present disclosure relate to wireless communications, and more particularly, to techniques for probabilistic shaping through asymmetric numeral systems.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provides a method of wireless communication by a receiver. The method includes receiving a communication; decoding the communication to obtain a symbol sequence that is associated with a non-uniform probabilistic shaping distribution; performing a plurality of operations of asymmetric numeral system (ANS) encoding on a reverse symbol sequence derived from the symbol sequence, wherein a first operation of the plurality of operations uses a first probability parameter and a first symbol of the reverse symbol sequence, and wherein a second operation of the plurality of operations uses a second probability parameter and a second symbol of the reverse symbol sequence that occurs after the first symbol of the reverse symbol sequence; and obtaining a binary sequence in accordance with the ANS encoding.

Another aspect provides a method of wireless communication at a transmitter. The method includes obtaining a binary sequence; performing a plurality of operations of ANS decoding on the binary sequence to obtain a symbol sequence, wherein an initial operation of the plurality of operations generates a first symbol using a first probability parameter derived from a target probabilistic shaping distribution, wherein the target probabilistic shaping distribution is a non-uniform probabilistic shaping distribution, and wherein a second operation of the plurality of operations generates a second symbol using a second probability parameter derived from the target probabilistic shaping distribution and the first symbol; and transmitting the symbol sequence.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram illustrating an example of probabilistic shaping (PS).

FIG. 6 is a diagram illustrating an example of asymmetric numeral system (ANS) encoding and decoding.

FIG. 7 is a diagram illustrating an example of PS using ANS.

FIG. 8 is a diagram illustrating an example of an ANS decoder (e.g., shaper) and an ANS encoder (e.g., de-shaper).

FIG. 9 is a diagram illustrating an example of PS using ANS, illustrated in the context of two symbols (A and B).

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for probabilistic shaping using asymmetric numeral systems.

A traditional modulation constellation, such as may be used for quadrature amplitude modulation (QAM), may be expected to have a uniform distribution of constellation points in terms of probability. For example, each constellation point of such a modulation constellation may have an equal probability of being used for transmission. However, a uniformly distributed modulation constellation may provide suboptimal performance in some scenarios. For example, different constellation points may be associated with different properties (e.g., energy expenditure, reliability), so it may be beneficial to bias selection of constellation points toward certain constellation points.

Probabilistic shaping (also referred to as distribution matching) provides a way to bias selection of constellation points toward certain constellation points. One candidate for probabilistic shaping is probabilistic amplitude shaping (PAS). In PAS, a distribution of the amplitude of the modulation constellation is shaped, and the sign of the modulation constellation is kept uniform. In PAS, shaping may be applied prior to channel coding, and a systematic forward error correction (FEC) may be used to preserve the shaping on the information bits. Parity bits may be mapped to the sign of the modulation constellation.

Probabilistic shaping may be source compression based or channel coding based. In channel coding based probabilistic shaping, a shaping distribution is applied at the channel coding stage. Examples of channel coding based probabilistic shaping include polar coding based shaping and Trellis coding based shaping. In source compression based probabilistic shaping, a shaping distribution is applied to input bit vectors of a modulation operation. Examples of source compression based probabilistic shaping include arithmetic coding (AC) based shaping and Huffman coding based shaping.

AC based shaping (which may include, for example, constant composition distribution matching (CCDM) or energy-based shaping) may provide flexibility and adequate performance. However, challenges arise in the implementation of AC based shaping. First, a description of AC based shaping is provided. Then, these challenges are described in further detail.

AC is a source compression technique that takes, as input, a sequence of non-uniformly distributed symbols, and converts the sequence of symbols to a set of uniformly distributed bits. In the context of probabilistic shaping, source decompression based on AC may be performed. For example, a probabilistic shaping (PS) module may take as input a set of uniformly distributed bits, and may output a sequence of symbols according to a target non-uniform distribution by performing source decompression. One complexity of PS is that PS uses a fixed-to-fixed mapping of input to output, but conventional source compression provides a variable length output. AC based shaping may address this complexity by adapting the probability distribution used during the source compression or decompression procedure dynamically based on the symbols or bits that were processed by the compressor or decompressor. Thus, AC based shaping may involve adaptive AC, and AC may be beneficial for PS because AC supports adaptive or data-dependent encoding and decoding. As used herein, “fixed-to-fixed mapping” may refer to a mapping from an input of a fixed length to an output of a fixed length.

AC encoding works by repeatedly dividing a current range based on the probability of each input symbol, and narrowing the current range to the subdivision corresponding to the next symbol in the input. The encoder may process each input symbol. For example, the encoder may divide the current range into subranges proportional to the probability of each possible symbol. The size of each subrange is determined by the probability of its corresponding symbol. The encoder may select the subrange that corresponds to the current input symbol, and may update the current range to be this selected subrange. As each input symbol is processed, the current range is repeatedly divided and narrowed down, focusing in on the subrange corresponding to the sequence of input symbols. After processing all input symbols, the final narrow range represents the encoded value. Any value within this final range can be used to uniquely decode the original input sequence.

AC is an example of entropy coding. Entropy coding is a lossless data compression technique that encodes information using a model of the statistical characteristics of the data. The core principle of entropy coding is to assign shorter codes to more frequent symbols and longer codes to less frequent symbols, thereby reducing the overall number of bits needed to represent the data. Another form of entropy coding is Huffman coding. Huffman codes are straightforward to implement (in a similar fashion to a lookup table of a certain size). However, the performance of Huffman codes is not as good as AC, and it is non-adaptive. AC achieves the asymptotic entropy of the source (for a wide class of sources). However, AC has implementation challenges. For example, AC involves re-scaling the subrange of a current range (e.g., unit interval) in each operation of the computation, which requires division and multiplication of fractional numbers. As a result, AC is much slower than Huffman codes.

Asymmetric numeral system (ANS) coding may provide a similar compression performance to AC at a similar compression speed to Huffman coding. As a simple example, consider compression of a source with two symbols {a, b}, where a has a probability of p and b has a probability of 1−p. In AC, we work with the probability of each symbol (which is fractional), and encode the sequence of source symbols as a fractional value inside an interval in (0, 1). In each operation of AC encoding, the sub-intervals in (0, 1) are scaled to have a unit length. In contrast, ANS encoding may use solely integer operations, and may encode the sequence of input symbols {a, b} as an integer number. For example, the encoder may quantize the probability to

$$\frac{{n}_{1}}{N} , \frac{{n}_{2}}{N} ,$$

where n₁, n₂, N are all integers such that n₁+n₂=N. In this example,

$$p \approx \frac{{n}_{1}}{N} and 1 - p \approx \frac{{n}_{2}}{N} .$$

The ANS coding may also use a cumulative distribution C={0, n₁}, which denotes the cumulative distribution function (CDF) of the quantized distribution (multiplied by N). When the source symbol is equiprobable over {a, b}, one can see that the integer representation of n source symbols is the decimal value associated with n bits (e.g., 0=a, 1=b). The values n₁ and n₂ may correspond to or represent a frequency of a quantized distribution. For example, n₁ may represent a probability of occurrence of a and n₁ may represent a probability of occurrence of b.

ANS coding may work sequentially. For example, let an initial state of the ANS encoder be defined as X₀=0. For each source symbol sₜ of n symbols at the input, the state is updated as

$${X}_{t} = ⌊ \frac{{X}_{t - 1}}{F ( {s}_{t} )} ⌋ \cdot N + C ( {s}_{t} ) + mod ( {X}_{t - 1} , F ( {s}_{t} ) ) .$$

In the two-symbol source example from above, F(a)=n₁ and F(b)=n₂; C(a)=0, and C(b)=n₁. That is, F represents the probability mass function (PMF) and C represents the cumulative mass function (CMF) of the source distribution (where each are multiplied by the common integer N to become integers). At the end of encoding at operation n (after all n symbols are processed), the ANS encoder output the binary expansion of the state parameter Xₙ.

The decoder of ANS works sequentially. For example, an ANS decoder may sequentially decode the symbol sequence sₜ in a reverse order from t=n to t=1 as follows:

$$slot = mod ( {X}_{t} , N )$$

$${s}_{t} = {C}_{i n v} ( slot )$$

$${X}_{t - 1} = ⌊ \frac{{X}_{t}}{N} ⌋ \cdot {F}_{{s}_{t}} + slot - {C}_{{s}_{t}}$$

Here, Cᵢₙᵥ is the inverse of the CDF. That is, Cᵢₙᵥ(y)=aⱼ if Cₐ_{ⱼ}≤y≤Cₐ_{ⱼ}₊₁ (for a given integer y between 0 and N−1).

ANS is inherently fixed point (since ANS can be configured to only utilize integers), and no fractional numbers are involved. Thus, ANS avoids the rescaling procedure in AC, so no division by fractional numbers is needed. ANS still involves integer divisions, but only to compute

$$\underline{N 2} = ⌊ \frac{N 2}{N 1} ⌋ * N 1 + mod ( N 2 , N 1 )$$

for the two integers N2, N1. The fractional values of these integers are not used. This can be compared to AC, in which fractional computations are performed (e.g., 4/7=0.571428 . . . ) up to a level of precision (e.g., 32 digits). In ANS, it suffices to know 4=0*7+4.

This is beneficial in improving the compression/decompression speed, reducing area, and avoiding any numerical issues and precision issues during standardization of the shaping scheme. For example, for AC based CCDM, the fixed-point version of CCDM may be specified in a wireless communication specification so that the transmitter (decompressor) and receiver (compressor) are fully aligned. Fractional numbers may provide significant challenges for such specifications, particularly when dealing with fractional numbers that have infinitely many decimals (e.g., 13/19, which occurs with some regularity in AC based CCDM). Another key benefit of ANS is that only one integer state Xₜ is monitored, whereas AC involves tracking two boundaries of the interval (two fractional numbers between 0 and 1). For this reason, ANS may use less memory (e.g., approximately 50% less memory) and provide better encoding/decoding speed (e.g., approximately 2× faster speed) than AC (e.g., depending on the specific implementations of AC and ANS).

One difference between ANS compression and AC is that ANS is a first in last out (FILO) scheme, whereas AC is FIFO (first in first out). For example, in ANS, the first symbol seen by the encoder will be decoded last by the decoder. This may mean that it is difficult to make ANS adaptive or data dependent. “Data dependency” may refer to changing a target distribution at the encoder at an operation t based on source symbols seen before t, and may be useful when a data source has dependencies (e.g., Markov sources). However, because ANS is FILO, the decoder may not know the distribution used to encode symbol Sₜ at transmission without knowing the source symbols prior to symbol Sₜ. It may be beneficial to use ANS for PS, since ANS provides more efficient performance than AC. However, as described earlier, PS involves a compressor and decompressor that is adaptive or data dependent in order to achieve fixed-to-fixed shaping. This lack of adaptiveness or data dependency in ANS (that is, some implementations of ANS) may hamper the implementation of ANS-based PS.

Aspects of the present disclosure relate generally to implementation of ANS-based PS. Some aspects more specifically relate to a modified ANS technique that renders ANS adaptive or data-dependent based on properties of PS. For example, the ANS techniques described herein may provide adaptiveness or data-dependency based on a pool of available symbols being adjusted at each operation of ANS encoding or decoding. Description is first provided of a receiver/encoding operation, then of a transmitter/decoding operation (since the receiver performs ANS encoding to obtain information bits that were previously “decoded” according to a target distribution at the transmitter).

The receiver may receive a signal and obtain a symbol sequence s=[s₀, . . . , s_{M-1}]∈S^{M} by performing channel decoding on the signal. The receiver may then obtain a reverse symbol sequence sᵣₑᵥ=[s_{M-1}, . . . , s₀]. The reverse symbol sequence enables the receiver to sequentially apply ANS encoding on the reverse symbol sequence using a probability distribution (e.g., a frequency and cumulative function, referred to herein as a probability parameter, a frequency parameter, and a cumulative parameter) that changes, in each operation t, after each symbol s_{M-t} is encoded at operation t. More specifically, in each operation of encoding the reverse symbol sequence to obtain the information, the receiver may update a probability distribution and may perform ANS encoding based on the updated probability distribution. This enables the receiver to perform adaptive or data-dependent ANS encoding. Finally, after all M symbols of sᵣₑᵥ have been ANS encoded, the receiver may output a binary sequence representing the information from the transmitter.

Notably, at each operation t of ANS encoding, the receiver uses a probability distribution that is based on source symbols (of sᵣₑᵥ) that were observed up to operation t. Thus, the receiver does not need to “look ahead” at later symbols of the reverse symbol sequence and the transmitter does not need to look ahead at later symbols of the natural symbol sequence, which guarantees that the transmitter/ANS decoder can obtain a same probability distribution as the receiver/ANS encoder. In this way, probabilistic shaping (at the transmitter) and de-shaping (at the receiver) can be reversible. Furthermore, by processing the reverse symbol sequence in the reverse order, the receiver enables the transmitter to generate the symbol sequence in a natural (e.g., causal) order.

The transmitter may obtain a binary information sequence. The transmitter may obtain a state parameter X_{M} from the binary information sequence. The transmitter may perform ANS decoding on the state parameter, over M operations, to obtain a set of M shaped symbols. In each operation denoted q, the transmitter may update a probability distribution (e.g., a frequency and cumulative function), and may perform ANS decoding based on the updated probability distribution. For example, at operation q∈{1, 2, . . . , M}, the probability distribution (e.g., frequencies/cumulative functions) is obtained based on the target shaping distribution, and the symbols s₀, . . . , s_{g-1} that are already generated from operation 1 to q−1. In this example, the probability distributions are updated in a reverse order relative to the receiver's updating of probability distributions. This is compatible with the FILO nature of ANS. Furthermore, the shaped symbol sequence [s₀, . . . , s_{M-1}], is generated in a forward order, which is possible because the receiver encodes or deshapes the symbol sequence in a reverse order.

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

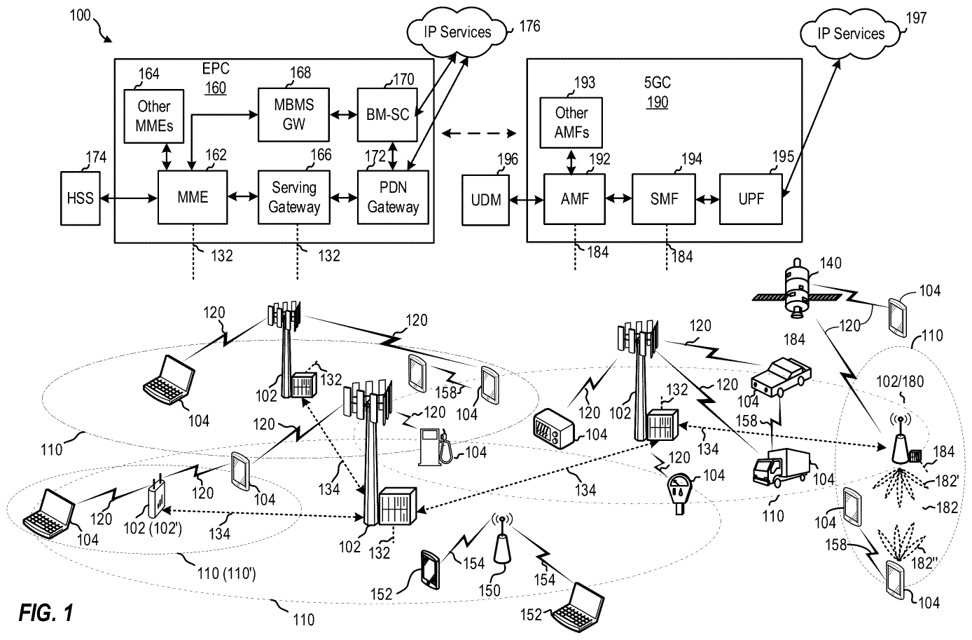

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (CNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

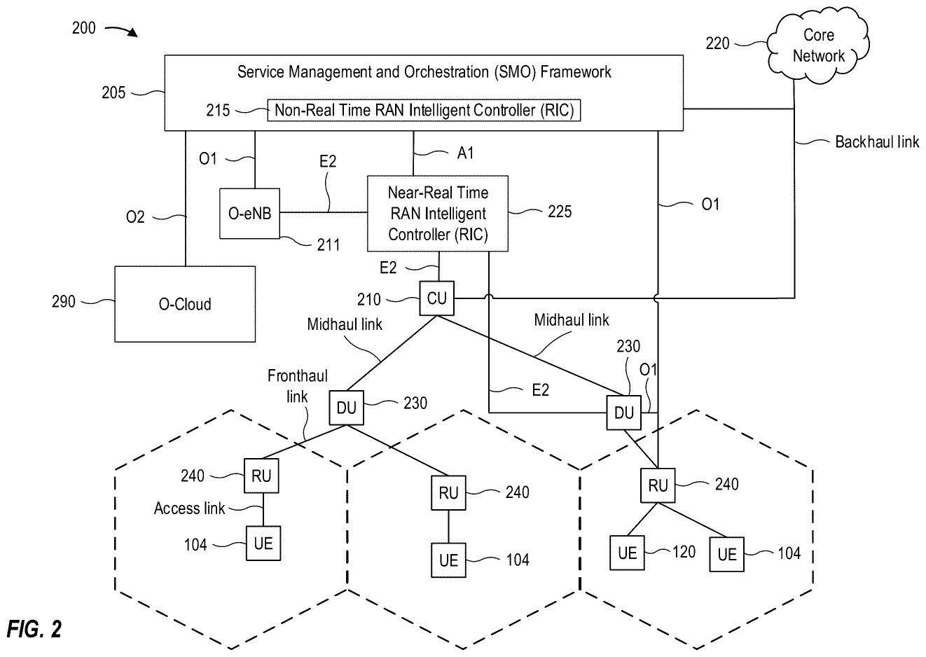

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

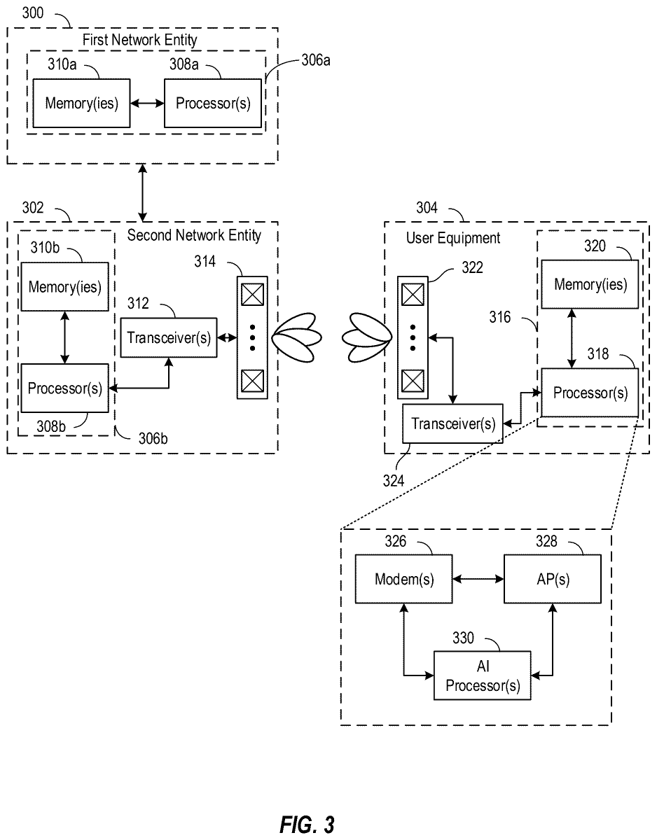

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes processing system 316, and one or more memories 320 coupled to the processing system 316. Further, UE 304 includes one or more antennas 322, one or more transceivers 324, and/or other components that enable wireless transmission and reception of data.

The processing system 316 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the processing system 316 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

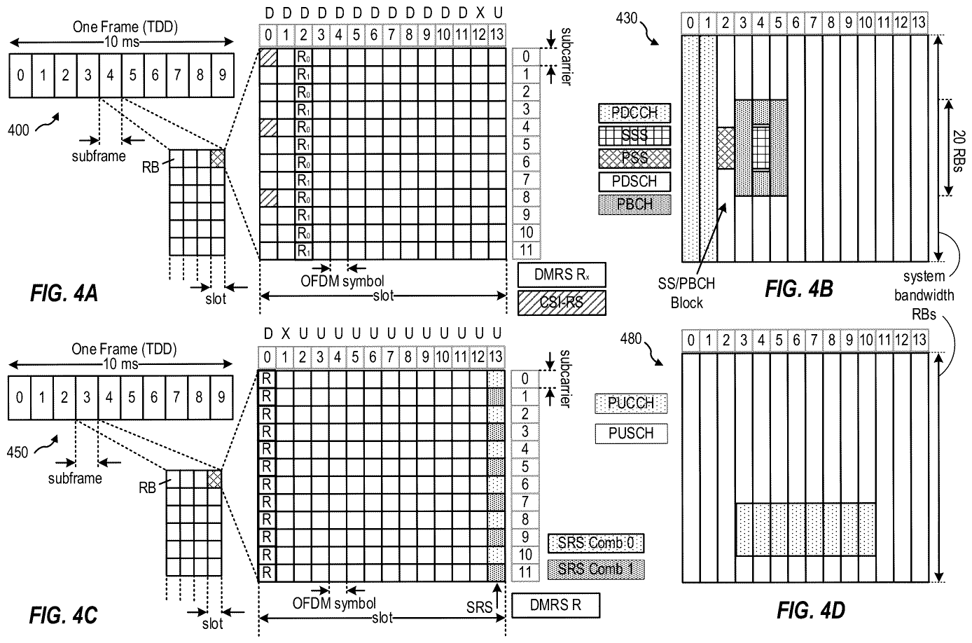

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

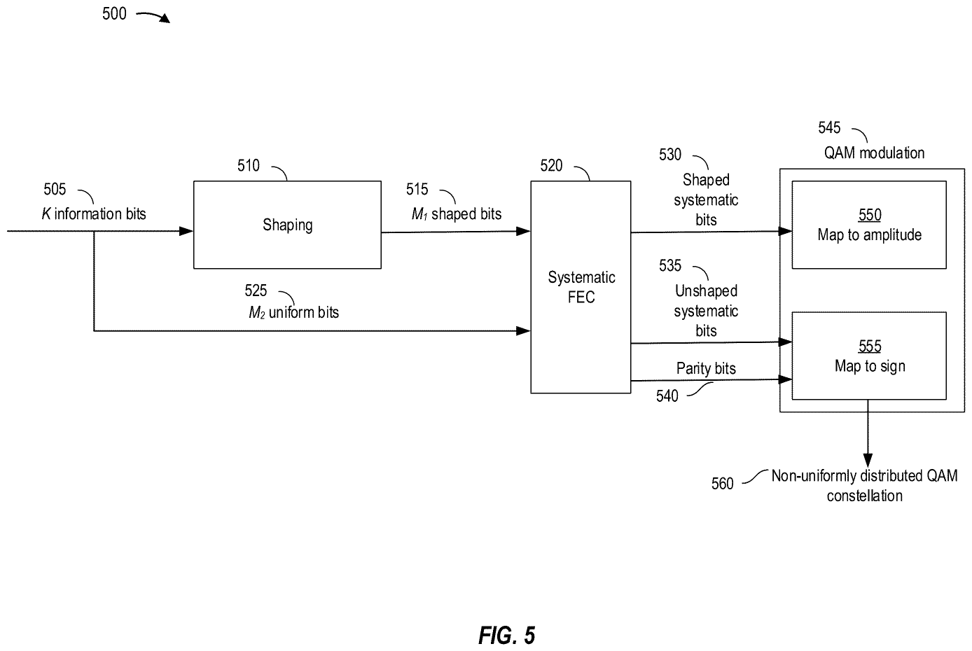

FIG. 5 is a diagram illustrating an example 500 of probabilistic shaping (PS). The operations of example 500 may be performed by a transmitter, such as UE 104, UE 304, BS 102, NE 300, or NE 302.

At 505, the transmitter may obtain a set of information bits (e.g., K information bits, where K is a number). For example, the transmitter may receive an input bit sequence. In some aspects, the input bit sequence may have a uniform probability distribution. For example, each bit of the input bit sequence may have an equal probability of having a first bit value or having a second bit value. As another example, the bit sequence, once subject to QAM modulation (without PS), may have an equal probability of being mapped to any constellation point of a QAM modulation constellation.

At 510, the transmitter may input the set of information bits (e.g., at least a subset of the set of information bits) to a shaper. At 515, the shaper may output a set of shaped bits (e.g., M₁ shaped bits). The shaper may perform one or more operations on the set of information bits, according to a non-uniform probability shaping distribution, to generate the set of shaped bits. The non-uniform probability shaping distribution may indicate a target probability for modulation of the set of information bits. For example, the non-uniform probability shaping distribution may indicate a target composition of a set of symbols, where the set of symbols may be used for the QAM modulation. As one example, for a set of symbols having possible symbol values A and B, the non-uniform probability shaping distribution may indicate a target composition of [A A B B B] (that is, three B symbols for every two A symbols), which can be denoted as M=5, m=[2,3]. Additional detail regarding non-uniform probability shaping distributions (which may also be referred to as target distributions) is provided elsewhere herein.

At 520, the transmitter may input the set of shaped bits and a set of uniform (e.g., unshaped) bits 525 to a FEC module. The FEC module may perform FEC (e.g., systematic FEC). At 530, the FEC module may output a set of shaped systematic bits. At 535, the FEC module may output a set of unshaped systematic bits. At 540, the FEC module may output a set of parity bits.

At 545, the transmitter may perform QAM modulation. As part of the QAM modulation, at 550, the transmitter may map the shaped systematic bits to an amplitude component of a QAM modulation constellation. As part of the QAM modulation, at 555, the transmitter may map the unshaped systematic bits and the parity bits to a sign component of the QAM modulation constellation. For example, the parity bits and the unshaped systematic bits may be used to determine sign bits. The parity bits and the second set of information bits may be fed to a sign mapper that generates two sign-bit sequences

$${b}_{M - 1}^{n} and {b}_{M}^{n}$$

over {−1, 1}. As an example, a negative sign (− or −1) may correspond to a bit value of 1, and a positive sign (e.g., + or +1) may correspond to a bit value of 0. The shaped systematic bits may be converted to amplitude pairs. The sign bits are pointwise multiplied with the amplitudes from the amplitudes pairs of the sequence sⁿ to form a real-valued modulation symbol. A pair of real-valued modulation symbols may form a complex-valued QAM modulation symbol. The resulting points of the constellation may be mapped to symbols for transmission. Thus, at 560, the transmitter may obtain a non-uniformly distributed QAM constellation.

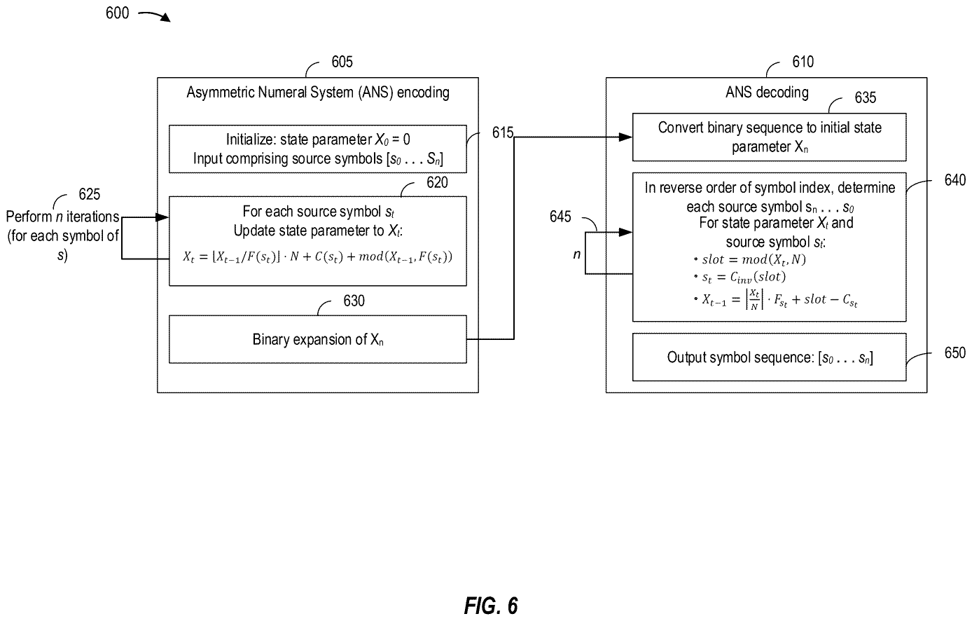

FIG. 6 is a diagram illustrating an example 600 of asymmetric numeral system (ANS) encoding and decoding. Example 600 includes an ANS encoder 605 and an ANS decoder 610. The operations of example 600 may be performed by an apparatus, such as a UE 104, a UE 304, a BS 102, an NE 300, or an NE 302. For example, the ANS encoder 605 may be implemented at processing system 306 or processing system 316. As another example, the ANS decoder 610 may be implemented at processing system 306 or processing system 316.

At 615, an apparatus may initialize the ANS encoder 605. For example, the apparatus may set a state parameter (sometimes referred to as a state variable and denoted X) to an initial value of 0. The initialized state parameter is denoted X₀.

The ANS encoder 605 performs a plurality of operations of ANS encoding. An operation of ANS encoding may include for example, an operation shown at 620. At 620, the ANS encoder 605, at a step t, may update the state parameter X to a value Xₜ. For example, the ANS encoder 605 may update the state parameter according to the formula Xₜ=└Xₜ₋₁/F(sₜ)┘·N+C(sₜ)+mod(Xₜ₋₁, F(sₜ)), where C denotes a cumulative density function of a quantized distribution of symbol values (multiplied by a common integer N) and F denotes a probability mass function of the quantized distribution of the signal values (multiplied by the common integer N).

As shown by reference number 625, the ANS encoder 605 may perform operations of ANS encoding iteratively. For example, the ANS encoder 605 may update the state parameter X for each source symbol sₜ of an input symbol sequence.

After the plurality of operations of ANS encoding, the ANS encoder 605 may output a final state parameter Xₙ. At 630, the ANS encoder 605 may output a binary expansion of the final state parameter Xₙ to obtain a binary sequence. The binary sequence maybe of a predetermined length. For example, the length may correspond to the number of information bits that are shaped by the ANS encoder 605 (that is, the number of bits that are input to the shaping block 510 in FIG. 5). In other words, if the state is 7 and the input length is 5, then the binary expansion is 00111. If the state is 13 and the input length is 5, then the binary expansion is 01101.

An apparatus (which may be a different apparatus than the apparatus that implements the ANS encoder 605) may decode the binary sequence. For example, at 635, the ANS decoder 610 may convert the binary sequence to an initial state parameter Xₙ (e.g., the same state parameter that was the final state parameter for the ANS encoder 605).

An operation of ANS decoding is shown at 640. Notably, ANS decoding is performed starting at a last (latest, highest) index of the symbol sequence s, and proceed to the first (earliest, lowest) index of the symbol sequence s. Thus, in an operation shown at 640, the ANS decoder 610 may determine a source symbol sₜ based on a state parameter Xₜ. For example, the ANS decoder 610 may define a parameter slot as slot=mod(Xₜ, N). The ANS decoder 610 may then determine the source symbol sₜ as Cᵢₙᵥ(slot), where Cᵢₙᵥ is the inverse of the CDF, i.e., Cᵢₙᵥ(y)=aⱼ if Cₐ_{ⱼ}≤y≤Cₐ_{ⱼ}₊₁ (for a given integer y between 0 and N−1). Finally, the ANS decoder 610 may update the state parameter (denoted Xₜ₋₁) for determination of a next symbol sₜ₋₁ as:

$${X}_{t - 1} = ⌊ \frac{{X}_{t}}{N} ⌋ \cdot {F}_{{s}_{t}} + slot - {C}_{{s}_{t}} .$$

The ANS decoder 610 may perform this operation iteratively (as shown at 645), for example, n times, to determine the full symbol sequence. The ANS decoder 610 may output the signal sequence s, comprising symbols s₀ through sₙ.

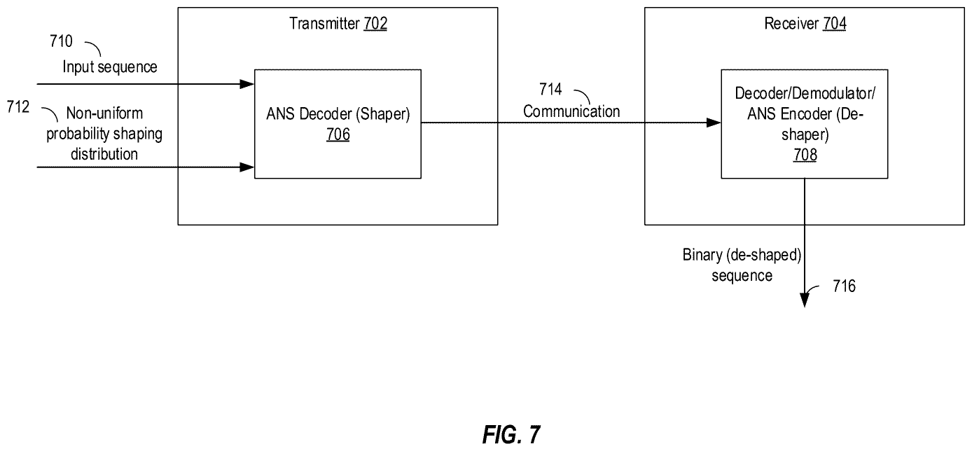

FIG. 7 is a diagram illustrating an example 700 of PS using ANS. Example 700 includes a transmitter 702 and a receiver 704. The transmitter 702 may be an example of a UE 104, a UE 304, a BS 102, an NE 300, or an NE 302. The receiver 704 may be an example of a UE 104, a UE 304, a BS 102, an NE 300, or an NE 302.

The transmitter 702 may include an ANS decoder (e.g., shaper) 706. The receiver 704 may include an ANS encoder (e.g., de-shaper) 708. Note that, for purposes of PS using ANS, a transmitter 702 performs ANS decoding and a receiver 704 performs ANS encoding. The ANS encoder 708 may be implemented at the processing system 306 or the processing system 316. The ANS decoder 706 may be implemented at the processing system 306 or the processing system 316. The ANS decoder 706 may be an example of the shaper described with respect to FIG. 5.

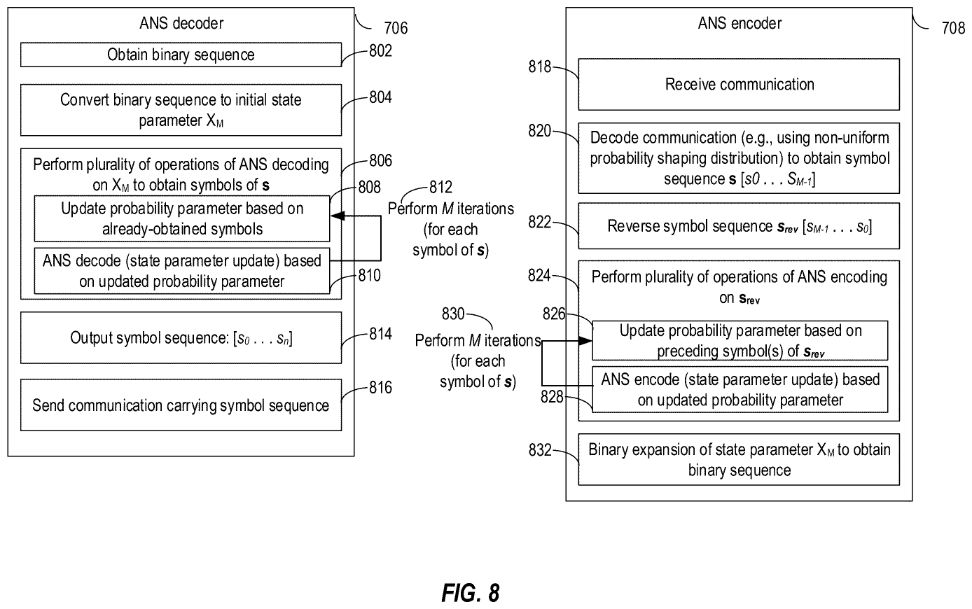

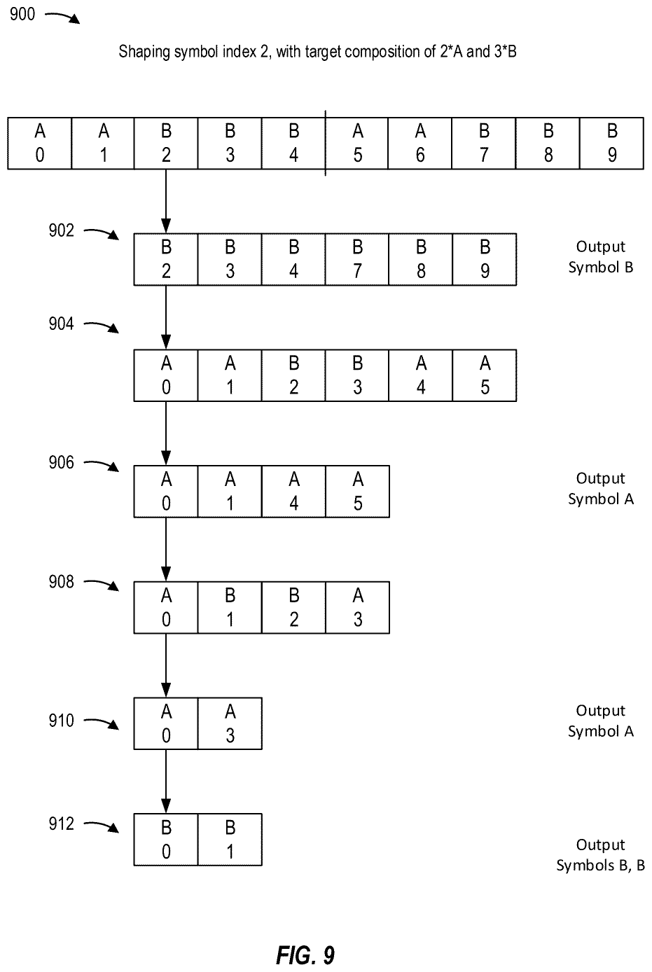

As shown, the transmitter 702 may provide, to the ANS decoder 706, an input sequence 710. In some aspects, the input sequence 710 may comprise a bit sequence. In some aspects, the input sequence 710 may comprise a symbol sequence (e.g., s). As further shown, the ANS decoder 706 may receive or be configured with a non-uniform probability shaping distribution 712. The ANS decoder 706 may use the non-uniform probability shaping distribution 712 to perform PS on the input sequence 710 by performing a plurality of operations of ANS decoding, as described with respect to FIGS. 8 and 9.

In some aspects, the ANS decoder 706 may use a non-uniform composition sequence (for example, a composition sequence of [3,2] for an example composition [AAABB]). For example, the transmitter 702 may determine the composition sequence (that is, a target composition) based on the non-uniform probability shaping distribution 712. For example, given a target probability Pr(A)=0.6, Pr(B)=0.4, and total symbol sequence length 5, the composition sequence may be [3,2].

Thus, using aspects described herein, the output symbol composition from the ANS decoder 706 may be the same as the target composition (or non-uniform probability shaping distribution 712). Thus, aspect described herein provide a form of constant composition distribution matching.

The ANS decoder 706 may output information, for example, in the form of a symbol sequence. The transmitter 702 may transmit the symbol sequence in a communication 714. The receiver 704 may receive the communication 714. The receiver 704 may decode and/or demodulate the communication 714. For example, the receiver 704 may decode and/or demodulate the communication using the non-uniform probability shaping distribution 712. In this example, the non-uniform probability shaping distribution 712 may be used to configure a soft demodulator of the receiver 704. As a result of demodulating and/or decoding the communication 714, the receiver 704 may obtain a symbol sequence. The receiver 704 may perform a plurality of operations of ANS encoding on the symbol sequence to obtain a binary sequence 716. As shown, the binary sequence 716 may be de-shaped. For example, the binary sequence 716 may have a same probability distribution (e.g., a uniform probability distribution) as the input sequence 710.

FIG. 8 is a diagram illustrating an example of an ANS decoder (e.g., shaper) 706 and an ANS encoder (e.g., de-shaper) 708. In some aspects, the shaping described with respect to FIGS. 5-9 may be referred to as constant-composition distribution matching (CCDM). In CCDM, an index (or a binary expansion of the index) is assigned to a symbol sequence, in a set of symbol sequences, with a fixed composition. For example, a set of symbols S may include L possible values: S={a₁, . . . , a_{L}}, where L is typically selected to be a power of 2 in PAS applications. The non-uniform probability shaping distribution may have a target distribution (also known as target composition) m=[m₁, . . . , m_{L}], where mⱼ denotes the frequency of symbol aⱼ; here, M=m₁+ . . . + my denotes the length of the symbol sequence. The total number of sequences with a fixed composition [m₁, . . . , m_{L}] can be computed via the multinomial

$$( \begin{matrix}M \\ {m}_{1} , {m}_{2} , … , {m}_{L}\end{matrix} ) = \frac{M !}{{m}_{1} ! {m}_{2} ! … {m}_{L} !} .$$

“Shaping” may include assigning a unique symbol sequence of composition [m₀, . . . , m_{L-1}] to an arbitrary binary sequence of length

$$K = ⌊ {log}_{2} ( \begin{matrix}M \\ {m}_{1} , {m}_{2} , … , {m}_{L}\end{matrix} ) ⌋ .$$

At 802, the ANS decoder 706 may obtain a binary sequence (e.g., input sequence 710, information bits shown at 505). In some aspects, the binary sequence may be associated with a uniform probability distribution.

At 804, the ANS decoder 706 may convert the binary sequence to an initial state parameter X_{M}. For example, the ANS decoder 706 may compute a decimal value of the binary sequence as the state parameter X_{M}.

At 806, the ANS decoder 706 may perform a plurality of operations of ANS decoding, using the state parameter X_{M}, to obtain symbols of a symbol sequence s. An operation of ANS decoding is illustrated at 808 and 810, collectively. In an initial operation, the ANS decoder 706 may initialize N¹=M and a frequency parameter as the non-uniform probability shaping distribution (e.g., [m₁, . . . , m_{L}], determined from the composition of the target shaping sequence, i.e.,

$${n}_{j}^{1} = {m}_{j} ,$$

j=1, . . . , L). A cumulative parameter may be derived from the non-uniform probability shaping distribution, as described below.

At 808, the ANS decoder 706 may update a probability parameter based on one or more symbols that have already been obtained as part of the ANS decoding. For example, at step q∈{1, 2, . . . , M}, the probability parameter is obtained based on the non-uniform probability shaping distribution, and based on the symbols s₀, . . . , s_{q-1} that are already generated from step 1 to step q−1, by setting N^{q}=M−q+1. A frequency parameter

$$[ {n}_{1}^{q} , … , {n}_{L}^{q} ]$$

is determined based on the composition of the remaining N^{q} symbols to be generated (e.g., as

$${n}_{j}^{q} = {m}_{j} - \# \{ 0 \leq k \leq q - 1 : {s}_{k} = {a}_{j} \} ) .$$

A cumulative parameter C^{q}(·) (which may be referred to as a cumulative function or a cumulative distribution) can be determined from

$$[ {n}_{1}^{q} , … , {n}_{L}^{q} ] .$$

For example, the cumulative parameter may indicate the partial sum of frequencies of occurrence of

$$[ {n}_{1}^{q} , … , {n}_{L}^{q} ] .$$

More particularly, the cumulative parameter may indicate the partial sum of frequencies of occurrence up to a given symbol point. For example, given a set of amplitude modulation symbols a₁, a₂, . . . , a_{L}. Then, C^{q}(aⱼ), j=1, . . . , L, is equal to n_1\hat{ }q+n_2\hat{ }q+ . . . +n_{j−1}\hat{ }q (that is, the sum of frequencies of occurrence prior to the symbol aⱼ).

At 810, the ANS decoder 706 may perform ANS decoding based on the updated probability parameter. For example, the ANS decoder 706 may determine a parameter slot as slot=mod(X_{q},N^{q}), may generate a symbol

$${s}_{q - 1} = {C}_{i n v}^{q} ( slot ) ,$$

and may update the state parameter as

$${X}_{M - q} = ⌊ \frac{{X}_{M - q + 1}}{{N}^{q}} ⌋ \cdot F ( {s}_{q - 1} ) + slot - {C}^{q} ( {s}_{q - 1} ) \cdot {C}_{i n v}^{q}$$

denotes the inverse of the cumulative function C^{q}. As indicated at 812, the ANS decoder 706 may perform the operations of ANS decoding iteratively. For example, the ANS decoder 706 may perform M iterations of the operations (e.g., one iteration to determine each symbol of the symbol sequence s) until all M source symbols have been generated. Notably, this ANS decoding generates the shaped symbol sequence in a forward order (from a lowest index of the symbol sequence to a highest index), meaning that the ANS decoder 706 does not need to look ahead in the symbol sequence to perform shaping.

In some aspects, when performing ANS decoding or updating the probability parameter, the ANS decoder 706 may check if integer values of the vector F(·) (which may have a dimension 1*L) contain a greatest common divisor (GCD) that is greater than 1. The GCD of two or more numbers is the greatest common factor number that divides the two or more numbers exactly. If the vector F(·) contains the GCD greater than 1, then the ANS decoder 706 may update the state parameter as:

$$\tilde{F} ( x ) = \tilde{F} ( x ) / gcd , = \frac{{N}_{t}}{gcd ’} , \tilde{C} ( x ) = C ( x ) / gcd$$

For example, when F=[2,4], N=6, C=[0,2], the ANS decoder 706 may update the state parameter using \tilde{F}=[1,2], Ñ=3, \tilde{C}=[0,1].

At 814, the ANS decoder 706 may output the symbol sequence s. The symbol sequence s may include a plurality of symbols [s₀, . . . , s_{M-1}], where s=[s₀, . . . , s_{M-1}]∈S^{M}. At 816, the ANS decoder 706 (e.g., a transmitter 702 associated with the ANS decoder 706) may send a communication carrying the symbol sequence s.

The ANS encoder 708 performs de-shaping of the symbol sequence s, such that the symbol sequence s is mapped to a binary sequence. Notably, the ANS encoder 708 applies ANS encoding on a reverse symbol sequence using a probability parameter (which may be referred to as a probability distribution, and which may include a frequency parameter such as a probability mass function and a cumulative parameter such as a cumulative density function) that changes after each symbol s_{M-t} is encoded in a step t. More specifically, the ANS encoder 708 (e.g., de-shaper) performs M steps sequentially to encode the M symbols into a state parameter X, which is transformed into uniformly distributed information bits via decimal number to binary conversion.

At 818, the ANS encoder 708 (e.g., a receiver 704 associated with the ANS encoder 708) may receive the communication carrying the symbol sequence s.

At 820, the ANS encoder 708 or the receiver 704 may decode the communication to obtain the symbol sequence s. For example, the ANS encoder 708 or the receiver 704 may use the non-uniform probability shaping distribution to decode or demodulate the communication, as described with respect to FIG. 7.

At 822, the ANS encoder 708 may reverse the symbol sequence s to determine sᵣₑᵥ. For example, the ANS encoder 708 may arrange the symbols of s as [sₙ, . . . , s₀].

At 824, the ANS encoder 708 may perform a plurality of operations of ANS encoding on the reverse symbol sequence. An operation of ANS encoding is illustrated at 826 and 828, collectively. As shown at 830, the ANS encoder 708 may perform multiple iterations, such as M iterations, of the operations of ANS encoding. Thus, the ANS encoder may update a state parameter for each symbol of s. In some aspects, in an initial operation of ANS encoding, the ANS encoder 708 may initialize a state parameter X as X₀=0.

Each operation of ANS encoding may include updating at 826 a probability parameter based on a symbol and zero or more preceding symbols of sᵣₑᵥ. For example, the ANS encoder 708 may update a frequency parameter and a corresponding cumulative parameter based on the symbol and the zero or more preceding symbols. In an initial operation, the ANS encoder 708 may identify a symbol s_{M-1}, update a probability parameter based on the identified symbol, and update the state parameter according to the identified symbol and the probability parameter. More specifically, at a step t (t=1, . . . , M) when processing symbol s_{M-t}, the ANS encoder 708 may update the probability parameter used for ANS encoding by setting N^{t}=t. A frequency parameter

$$[ {n}_{1}^{t} , . . , {n}_{L}^{t} ]$$

may indicate frequency of the symbols a₁, . . . , a_{L} in the partial sequence [s_{M-1}, . . . , s_{M-t}] (that is, the first t symbols in the reverse symbol sequence sᵣₑᵥ, or equivalently the symbol s_{M-1} and the zero or more preceding symbols before symbol s_{M-t}). Thus, the frequency parameter may indicate one or more frequencies of occurrence

$$( [ {n}_{1}^{t} , … , {n}_{L}^{t} ] )$$

of one or more symbols (a₁, . . . , a_{L}) that precede a symbol (s_{M-1}) in the reverse symbol sequence. The cumulative parameter may indicate a sum of the one or more frequencies of occurrence of the one or more symbols that precede the symbol s_{M-t} in the reverse symbol sequence. In some aspects, the cumulative parameter may indicate a sum of the one or more frequencies of occurrence of the symbol s_{M-t} and the one or more symbols that precede the symbol s_{M-t} in the reverse symbol sequence. The cumulative parameter (which may be referred to as a cumulative function) may be based on the frequency parameter. For example, the cumulative parameter C^{t}(·) can may be determined as

$${C}^{t} ( {a}_{j} ) = {\sum }_{k = 1}^{j - 1} {n}_{k}^{t} .$$

At 828, the ANS encoder 708 may update the state parameter X as X, using the probability parameter and the symbol s_{M-t}. For example, the ANS encoder 708 may update the state parameter as Xₜ=└Xₜ₋₁/F^{t}(s_{M-t})┘·N^{t}+C^{t}(s_{M-t})+mod(Xₜ₋₁, F^{t}(s_{M-t})). At 830, the ANS encoder may repeat the operation indicated by 826 and 828 for M iterations, until all M symbols of sᵣₑᵥ are encoded.

In some aspects, when performing ANS encoding or updating the probability parameter, the ANS encoder 708 may check if integer values of the vector F(·) (which may have a dimension 1*L) contain a GCD that is greater than 1. If the vector F(·) contains the GCD greater than 1, then the ANS encoder 708 may update the state parameter as:

$$\tilde{F} ( x ) = \tilde{F} ( x ) / gcd , \tilde{{N}_{t}} = \frac{{N}_{t}}{gcd ’} , \tilde{C} ( x ) = C ( x ) / gcd$$

For example, when F=[2,4], N=6, C=[0,2], the ANS encoder 708 may update the state parameter using \tilde{F}=[1,2], Ñ=3, \tilde{C}=[0,1].

After performing the plurality of operations of ANS encoding, the ANS encoder 708 may have a state parameter X_{M}. The ANS encoder 708 may perform binary expansion of the state parameter X_{M} at 832 to obtain a binary sequence (e.g., the same binary sequence that was obtained at 802).

Thus, at each step of ANS encoding, the ANS encoder 708 uses a probability parameter (e.g., frequency parameter) that is based on source symbols that were observed up to step t. Therefore, no look ahead needs to be used at the ANS decoder 706. This guarantees that the ANS decoder 706 can obtain the same probability distribution as the ANS encoder 708, which ensures that the shaping/deshaping operations are reversible. Furthermore, the deshaper (ANS encoder 708) processes the (shaped) symbols in a reverse order, which implies that the shaper (ANS decoder 706) is able to generate the symbols in a natural or causal order.

As a simple example, consider an example with source symbols having possible values of A and B, with a non-uniform probability shaping distribution indicating 4 A's and 2 B's. This can be expressed as =6, m=[4,2]. There are a total of

$$( \begin{matrix}6 \\ 2\end{matrix} ) = 15$$

such sequences. Thus, the transmitter may be able to shape K=└log₂ 15┘=3 information bits. Operations of the receiver are described prior to operations of the transmitter, since the receiver performs ANS encoding and the transmitter performs ANS decoding.

At a receiver (e.g., ANS encoder 708), the receiver may receive a symbol sequence “ABABAA”. The receiver may first determine the reversed sequence “AABABA”. The receiver (e.g., de-shaper, ANS encoder 708) may apply an ANS encoder with a probability parameter that changes from step to step. The receiver may initialize a state parameter X₀ to X₀=0. Since the first element of the (reversed symbol sequence) is A, the receiver may initialize the probability parameter as N¹=1, C¹={0,1},

$${n}_{1}^{1} = 1 ,$$

$${n}_{2}^{1} = 0 ,$$

which is a singleton distribution Pr(S₁=A)=1. The receiver may then compute the state parameter as follows: X₁=└0/1┘·1+0+0=0. The second source symbol is also A. The probability parameter is updated as N²=2, C¹={0,2},

$${n}_{1}^{1} = 2 , {n}_{2}^{1} = 0 .$$

Then, X₂=└0/2┘·2+0+mod(0,2)=0. The third source symbol is B. The probability parameter is updated as N³=3, C¹={0,2},

$${n}_{1}^{1} = 2 ,$$

$${n}_{2}^{1} = 1.$$

The state parameter is updated as X₃=└0/1┘·3+2+mod(2,1)=2. The fourth source symbol is A. The probability parameter is updated as as N⁴=4, C¹={0,3},

$${n}_{1}^{1} = 3 ,$$

$${n}_{2}^{1} = 1 .$$

The state parameter is updated as X₄=└2/3┘·4+0+2=2. The fifth source symbol is B. The probability parameter is updated as N⁵=5, C¹={0,3},

$${n}_{1}^{1} = 3 ,$$

$${n}_{2}^{1} = 2 .$$

The state parameter is updated as X₅=└2/2┘·5+3+mod(2,2)=8. The sixth source symbol is A. The probability parameter is updated as N⁶=6, C¹={0,4},

$${n}_{1}^{1} = 4 ,$$

$${n}_{2}^{1} = 2 .$$

The state parameter is updated as X₆=└8/4┘·6+0+mod(8,4)=12. The receiver may output the binary expansion of 12, which is [1,1,0,0].

Continuing the above example, at the transmitter, the input to the shaper (e.g., ANS decoder) is [1,1,0,0]. The transmitter may generate the state parameter X₆=12. The transmitter may initialize the probability parameter based on the composition of the non-uniform probability shaping distribution:

$${N}^{1} = 6 , {C}^{1} = \{ 0 , 4 \} ,$$

$${n}_{1}^{1} = 4 , {n}_{2}^{1} = 2 .$$

The transmitter may perform ANS decoding as follows: Slot=mod(X₆,N¹)=0;

$${S}_{0} = {C}_{i n v}^{1} ( 0 ) = A ; {X}_{5} = ⌊ \frac{{X}_{6}}{{N}^{1}} ⌋ \cdot F ( A ) + slot - {C}^{1} ( A ) = 8 + 0 - 0 = 8 .$$

Note that, in this step, symbol S₀=a is generated. Next, the transmitter may update the probability parameter by excluding the already generated A from the non-uniform probability shaping distribution. Hence, N²=5, C²={0,3},

$${n}_{1}^{1} = 3 ,$$

$${n}_{2}^{1} = 2 .$$

The transmitter may perform ANS decoding using this updated probability parameter as follows: Slot=mod(X₅, N²)=3;

$${S}_{1} = {C}_{i n v}^{2} ( 3 ) = B ;$$

$${X}_{4} = ⌊ \frac{{X}_{5}}{{N}^{2}} ⌋ \cdot F ( B ) + slot - {C}^{1} ( A ) = 2 + 3 - 3 = 2.$$

Note that, in this step, symbol S₁=b is generated. The transmitter may update the probability parameter by excluding the already generated a, b from the non-uniform probability shaping distribution. Hence, N³=4,

$${C}^{2} = \{ 0 , 3 \} ,$$

$${n}_{1}^{1} = 3 , {n}_{2}^{1} = 1 .$$

The transmitter may perform ANS decoding using the updated probability parameter as follows: Slot=mod(X₄, N³)=2;

$${S}_{2} = {C}_{i n v}^{2} ( 2 ) = A ;$$

$${X}_{3} = ⌊ \frac{{X}_{4}}{{N}^{2}} ⌋ \cdot F ( A ) + slot - {C}^{1} ( A ) = 0 + 2 - 0 = 2 .$$

Note that, in this step, symbol S₂=a is generated. The transmitter may update the probability parameter as N²=3, C²={0,2},

$${n}_{1}^{1} = 2 ,$$

$${n}_{2}^{1} = 1 .$$

The transmitter may perform ANS decoding as follows: Slot=mod(X₃, N²)=2;

$${S}_{2} = {C}_{i n v}^{2} ( 2 ) = B ;$$

$${X}_{2} = ⌊ \frac{{X}_{4}}{{N}^{2}} ⌋ \cdot F ( B ) + slot - {C}^{1} ( A ) = 0 + 2 - 2 = 0 .$$

Note that, in this step, symbol S₂=B is generated. After this step, the state parameter has been set to zero. Since the state is equal to 0, the transmitter may determine that the remaining source symbols must all be A. Thus, the generated symbol sequence is ABABAA, which was input to the receiver as described above. Note that, in this example, the transmitter can transmit the symbol sequence before explicitly performing all operations of the ANS decoding, since the transmitter determines that all remaining symbols are A.

FIG. 9 is a diagram illustrating an example 900 of PS using ANS, illustrated in the context of two symbols (A and B). Example 900 illustrates how PS using ANS is performed. Example 900 uses a non-uniform probability shaping distribution of [A A B B B], indicating that three B symbols are desired for every two A symbols. This can be expressed as M=5, m=[2,3]. There are a total of

$$( \begin{matrix}5 \\ 2\end{matrix} ) = 10$$

such sequences. For purpose of illustration, assume that the number of info bits is log₂ 10 (that is, this example allows fractional bits for purpose of illustration). The goal of the shaper (e.g., ANS decoder) is to assign each index [0, 1, . . . , 9] to a length-5 symbol sequence.

The index of the symbol in the first row in example 900 stands for the state X_{M} (i.e., the initial state seen by the shaper), each corresponding to a binary sequence. The example 900 shows that, if the state X_{M} is 2 (which corresponds to the binary sequence 010 (since we can only transmit 3 bits with 10 total states)), then after ANS decoding, the symbol sequence ABAAAAB (as shown by the arrows 902, 904, . . . , 912) may be generated. As shown, each index is associated with a respective symbol value: for states 0, 1, 5, and 6, the first output symbol value is A, and for states 2, 3, 4, 7, 8, and 9 the first output symbol value is B. Thus, the indexes are assigned symbol values using a periodic pattern, where in each period of length 5, there are 2 indexes associated with symbol value A and 3 indexes associated with symbol value B.

Example 900 is described with regard to processing of index 2, and illustrates how to decode a symbol sequence from state X_{M}=2, where M is 5. As a summary, the symbol value associated with an index provides the first shaped symbol value from the shaper. For index 2, therefore, the first shaped symbol value is B. After the first symbol is selected at 902, all indices associated with the first shaped symbol value of B are kept for shaping, and indices associated with shaped symbol values of A are removed, as also illustrated at 902. Then, at 904, the indices associated with the first shaped symbol value of B are renumbered using a natural order (e.g., 0, 1, 2, 3, 4, 5) (corresponding to updating of a state parameter) and are assigned updated symbol values (illustrated as A, A, B, B, A, A) based on which symbol values have already been assigned (corresponding to updating of a probability parameter). Here, B has already been assigned once, so the updated symbol values include two A values and two B values (per periodic pattern of four indices).

At 906, the shaper outputs symbol A because of updated index 0 being associated with the symbol value A. All indices associated with the second shaped symbol value of A are kept for shaping, and indices associated with the shaped symbol value of B are removed, as also illustrated at 906. Then, at 908, the indices associated with the first shaped symbol value of B are renumbered using a natural order (e.g., 0, 1, 2, 3, 4, 5) and are assigned updated symbol values (illustrated as A, A, B, B, A, A) based on which symbol values have already been assigned. Here, A and B have each been assigned once, so the updated symbol values include one A value and two B values (per periodic pattern of three indices).

At 910, the shaper outputs symbol A because of updated index 0 being associated with the symbol value A. All indices associated with the second shaped symbol value of A are kept for shaping, and indices associated with the shaped symbol value of B are removed, as also illustrated at 910. After A is selected at 910, only symbol values of B remain. Thus, at 912, the shaper outputs a final two symbols of B, B. Therefore, index 2 is shaped with a symbol sequence of B, A, A, B, B. Thus, the shaping is terminated early (once only a single symbol value remains).

PS using ANS (as described with respect to FIGS. 5-9) may provide a shaping rate or efficiency that is commensurate (e.g., the same as) with arithmetic coding based CCDM. Furthermore, PS using ANS avoids multiplication and division of fractional numbers or ratios, and avoids scaling and rescaling of intervals between zero and 1. Thus, PS using ANS is simpler to implement, faster to run, and less memory-intensive than arithmetic coding based CCDM. PS using ANS also avoids numerical issues that arise with arithmetic coding based CCDM. Furthermore, PS using ANS may improve the compression/decompression speed, reduce area, and avoiding any numerical or precision issues during standardization of the shaping scheme. For example, for arithmetic coding based CCDM, a standard may explicitly specify the fixed-point version of CCDM so that the transmitter and the receiver have perfect alignment of the procedure. In this scenario, special attention needs to be paid when dealing with fractional numbers that have infinitely many decimals (e.g., 13/19) (which happens very often in arithmetic coding based CCDM). Another benefit of ANS is that only one integer state Xₜ is monitored, whereas arithmetic coding involves keeping track of two boundaries of the interval (two fractional numbers between 0 and 1). For this reason, ANS may have less memory usage (˜50%) and better speed (approximately 2×) compared to arithmetic coding.

In some aspects, an ANS encoder on the receiver side is operating on the reversed symbol sequence relative to the symbol sequence generated by the ANS decoder on the transmitter side. In some aspects, the transmitter side transmits the generated symbol sequence as is, and the receiver side does the symbol reversing operation. Alternatively, the transmitter may transmit the symbol sequence in the reverse manner, so that the receiver does not need to perform the reversing operation.

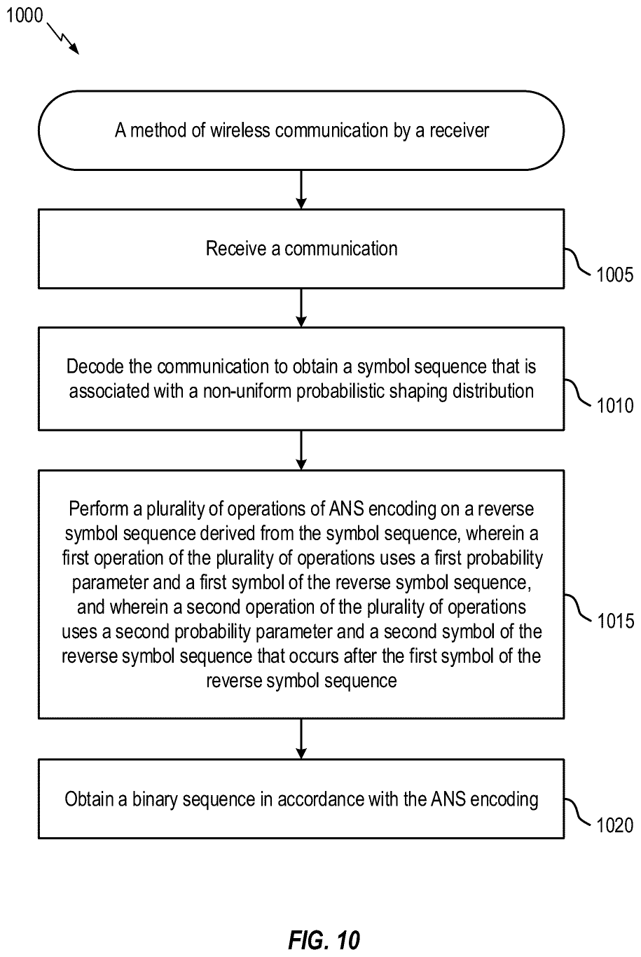

FIG. 10 shows a method 1000 for wireless communication by a receiver, such as UE 104 of FIG. 1 or UE 304 of FIG. 3.

Method 1000 begins at block 1005 with receiving a communication (e.g., at 714 or 818).

Method 1000 then proceeds to block 1010 with decoding the communication (e.g., at 714 or 820) to obtain a symbol sequence that is associated with a non-uniform probabilistic shaping distribution.

Method 1000 then proceeds to block 1015 with performing a plurality of operations (e.g., at 824, 826, and 828) of ANS encoding on a reverse symbol sequence derived from the symbol sequence, wherein a first operation (826, 828) of the plurality of operations uses a first probability parameter and a first symbol of the reverse symbol sequence, and wherein a second operation (826, 828) of the plurality of operations uses a second probability parameter and a second symbol of the reverse symbol sequence that occurs after the first symbol of the reverse symbol sequence.

Method 1000 then proceeds to block 1020 with obtaining a binary sequence (e.g., at 832) in accordance with the ANS encoding.

In some aspects, the second probability parameter is based on one or more symbols that precede the second symbol in the reverse symbol sequence.

In some aspects, the one or more symbols include the first symbol.

In some aspects, the one or more symbols include every symbol, of the reverse symbol sequence, that precedes the second symbol.

In some aspects, the second probability parameter is further based on the second symbol.

In some aspects, the second probability parameter includes a frequency parameter and a cumulative parameter.

In some aspects, the frequency parameter indicates one or more frequencies of occurrence of one or more symbols that precede the second symbol in the reverse symbol sequence.

In some aspects, the cumulative parameter indicates a sum of the one or more frequencies of occurrence of the one or more symbols that precede the second symbol in the reverse symbol sequence.

In some aspects, block 1015 includes updating a corresponding probability parameter in each operation of the plurality of operations.

In some aspects, the symbol sequence includes a plurality of symbols in a first order from a lowest symbol index to a highest symbol index, and wherein the reverse symbol sequence includes the plurality of symbols in a second order from the highest symbol index to the lowest symbol index.

In some aspects, the binary sequence is associated with a uniform probabilistic distribution.

In some aspects, block 1015 includes performing the first operation, the first operation comprising: identifying the first symbol; updating a probability parameter, based on the first symbol, to obtain the first probability parameter; and updating a state parameter according to the first symbol and the first probability parameter.

In some aspects, block 1020 includes obtaining the binary sequence based on the state parameter.

In some aspects, decoding the communication is based on the non-uniform probabilistic shaping distribution.

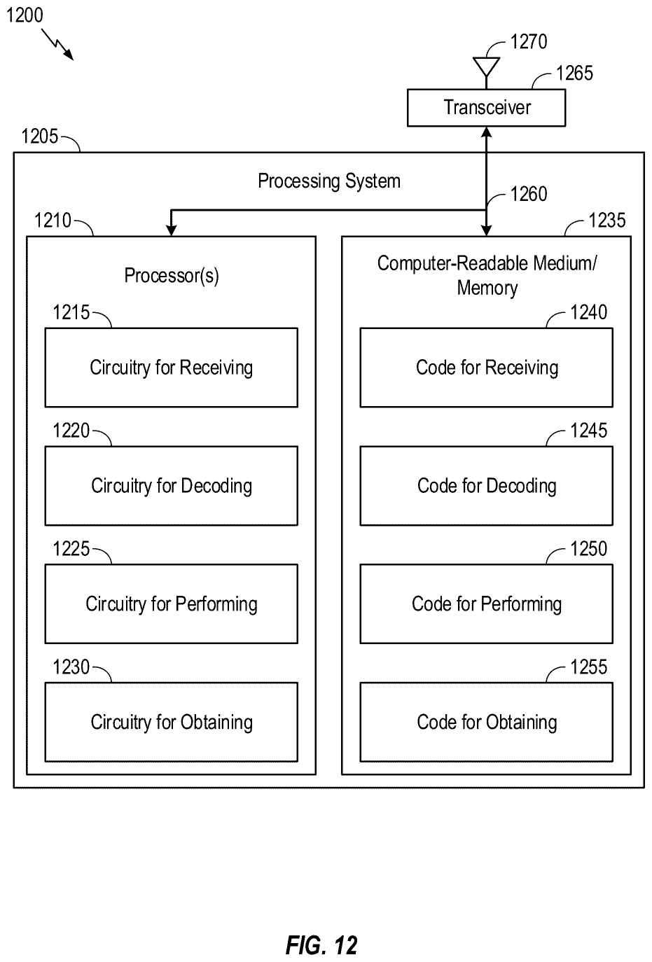

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Transmitter

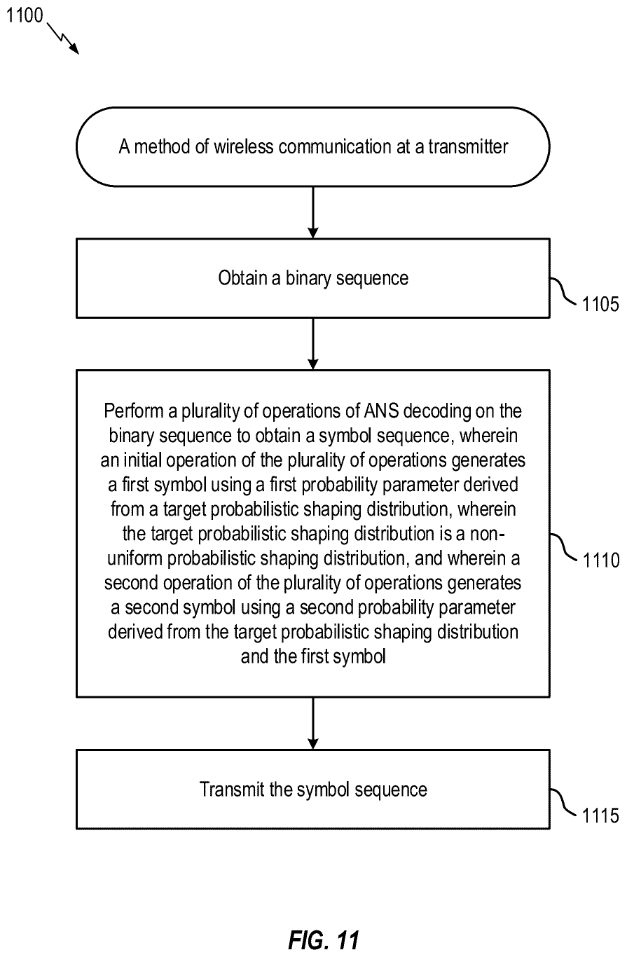

FIG. 11 shows a method 1100 for wireless communication at a transmitter, such as UE 104 of FIG. 1 or UE 304 of FIG. 3.

Method 1100 begins at block 1105 with obtaining a binary sequence (e.g., at 505, 710, or 802).

Method 1100 then proceeds to block 1110 with performing a plurality of operations (e.g., 806, 808, 810) of ANS decoding on the binary sequence to obtain a symbol sequence(s), wherein an initial operation of the plurality of operations generates a first symbol using a first probability parameter derived from a target probabilistic shaping distribution, wherein the target probabilistic shaping distribution is a non-uniform probabilistic shaping distribution, and wherein a second operation of the plurality of operations generates a second symbol using a second probability parameter derived from the target probabilistic shaping distribution and the first symbol.

Method 1100 then proceeds to block 1115 with transmitting the symbol sequence (e.g., at 816).

In some aspects, the first probability parameter includes a first frequency parameter and a first cumulative parameter, wherein the first frequency parameter indicates a first set of frequencies of occurrence corresponding to each symbol of the symbol sequence according to the target probabilistic shaping distribution, and wherein the first cumulative parameter indicates a sum of the first set of frequencies of occurrence.

In some aspects, the second probability parameter includes a second frequency parameter and a second cumulative parameter, wherein the second frequency parameter indicates a second set of frequencies of occurrence corresponding to remaining symbols, of the symbol sequence, other than the first symbol.

In some aspects, the second cumulative parameter indicates a sum of the second set of frequencies of occurrence.

In some aspects, the symbol sequence has a plurality of possible symbol values, wherein block 1115 includes transmitting the symbol sequence prior to performing all operations of the plurality of operations in accordance with remaining symbols of the symbol sequence only a single possible symbol value of the plurality of possible symbol values.

In some aspects, method 1100 further includes generating a state parameter using the binary sequence, wherein the plurality of operations are based on the state parameter.

In some aspects, block 1110 includes performing the first operation, the first operation comprising: identifying the first symbol; updating a probability parameter, based on the first symbol, to obtain the first probability parameter; and updating a state parameter according to the first symbol and the first probability parameter.

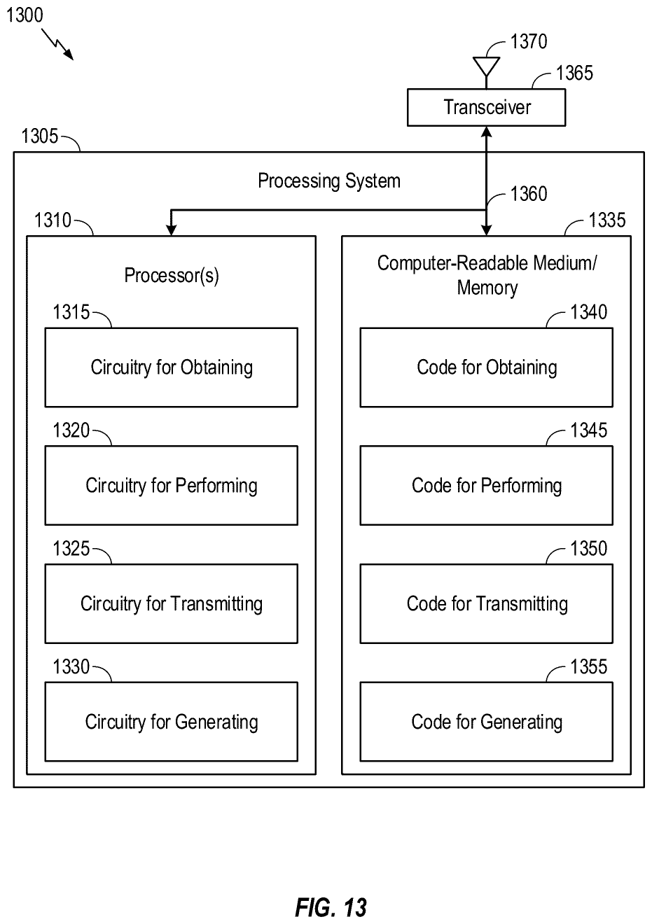

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3. In some aspects, communications device 1200 is a network entity, such as BS 102, NE 300, or NE 302.

The communications device 1200 includes a processing system 1205 coupled to a transceiver 1265 (e.g., a transmitter and/or a receiver). The transceiver 1265 is configured to transmit and receive signals for the communications device 1200 via an antenna 1270, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1235. In various aspects, the one or more processors 1210 may be representative of the processing system 316 described with respect to FIG. 3. The one or more processors 1210 are coupled to a computer-readable medium/memory 1235 via a bus 1260. In some aspects, the computer-readable medium/memory 1235 may be representative of the one or more memories 320 described with respect to FIG. 3. The computer-readable medium/memory 1235 is a non-transitory computer-readable medium/memory. In certain aspects, the computer-readable medium/memory 1235 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1235 stores code (e.g., executable instructions), including code for receiving 1240, code for decoding 1245, code for performing 1250, and code for obtaining 1255. Processing of the code 1240-1255 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry for receiving 1215, circuitry for decoding 1220, circuitry for performing 1225, and circuitry for obtaining 1230. Processing with circuitry 1215-1230 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, one or more transceivers 312, one or more antenna 314 and/or processing system 306 of the NE 300 or 302 illustrated in FIG. 3, transceiver 1265 and/or antenna 1270 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, one or more transceivers 312, one or more antenna 314 and/or processing system 306 of the NE 300 or 302 illustrated in FIG. 3, transceiver 1265 and/or antenna 1270 of the communications device 1200 in FIG. 12, and/or one or more processors 1210 of the communications device 1200 in FIG. 12.

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3. In some aspects, communications device 1300 is a network entity, such as BS 102, NE 300, or NE 302.

The communications device 1300 includes a processing system 1305 coupled to a transceiver 1365 (e.g., a transmitter and/or a receiver). The transceiver 1365 is configured to transmit and receive signals for the communications device 1300 via an antenna 1370, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, the one or more processors 1310 may be representative of the processing system 316 described with respect to FIG. 3. The one or more processors 1310 are coupled to a computer-readable medium/memory 1335 via a bus 1360. In some aspects, the computer-readable medium/memory 1335 may be representative of the one or more memories 320 described with respect to FIG. 3. The computer-readable medium/memory 1335 is a non-transitory computer-readable medium/memory. In certain aspects, the computer-readable medium/memory 1335 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1335 stores code (e.g., executable instructions), including code for obtaining 1340, code for performing 1345, code for transmitting 1350, and code for generating 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for obtaining 1315, circuitry for performing 1320, circuitry for transmitting 1325, and circuitry for generating 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, one or more transceivers 312, one or more antenna 314 and/or processing system 306 of the NE 300 or 302 illustrated in FIG. 3, transceiver 1365 and/or antenna 1370 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, one or more transceivers 312, one or more antenna 314 and/or processing system 306 of the NE 300 or 302 illustrated in FIG. 3, transceiver 1365 and/or antenna 1370 of the communications device 1300 in FIG. 13, and/or one or more processors 1310 of the communications device 1300 in FIG. 13.

### Example Clauses

Implementation examples are described in the following numbered clauses:
Clause 1: A method of wireless communication by a receiver, comprising: receiving a communication; decoding the communication to obtain a symbol sequence that is associated with a non-uniform probabilistic shaping distribution; performing a plurality of operations of ANS encoding on a reverse symbol sequence derived from the symbol sequence, wherein a first operation of the plurality of operations uses a first probability parameter and a first symbol of the reverse symbol sequence, and wherein a second operation of the plurality of operations uses a second probability parameter and a second symbol of the reverse symbol sequence that occurs after the first symbol of the reverse symbol sequence; and obtaining a binary sequence in accordance with the ANS encoding.
Clause 2: The method of Clause 1, wherein the second probability parameter is based on one or more symbols that precede the second symbol in the reverse symbol sequence.
Clause 3: The method of Clause 2, wherein the one or more symbols include the first symbol.
Clause 4: The method of Clause 2, wherein the one or more symbols include every symbol, of the reverse symbol sequence, that precedes the second symbol.
Clause 5: The method of Clause 2, wherein the second probability parameter is further based on the second symbol.
Clause 6: The method of any one of Clauses 1-5, wherein the second probability parameter includes a frequency parameter and a cumulative parameter.
Clause 7: The method of Clause 6, wherein the frequency parameter indicates one or more frequencies of occurrence of one or more symbols that precede the second symbol in the reverse symbol sequence.
Clause 8: The method of Clause 7, wherein the cumulative parameter indicates a sum of the one or more frequencies of occurrence of the one or more symbols that precede the second symbol in the reverse symbol sequence.
Clause 9: The method of any one of Clauses 1-8, wherein performing the plurality of operations of ANS encoding comprises updating a corresponding probability parameter in each operation of the plurality of operations.
Clause 10: The method of any one of Clauses 1-9, wherein the symbol sequence includes a plurality of symbols in a first order from a lowest symbol index to a highest symbol index, and wherein the reverse symbol sequence includes the plurality of symbols in a second order from the highest symbol index to the lowest symbol index.
Clause 11: The method of any one of Clauses 1-10, wherein the binary sequence is associated with a uniform probabilistic distribution.
Clause 12: The method of any one of Clauses 1-11, wherein performing the plurality of operations comprises performing the first operation, the first operation comprising: identifying the first symbol; updating a probability parameter, based on the first symbol, to obtain the first probability parameter; and updating a state parameter according to the first symbol and the first probability parameter.
Clause 13: The method of Clause 12, wherein obtaining the binary sequence comprises obtaining the binary sequence based on the state parameter.
Clause 14: The method of any one of Clauses 1-13, wherein decoding the communication is based on the non-uniform probabilistic shaping distribution.
Clause 15: A method of wireless communication at a transmitter, comprising: obtaining a binary sequence; performing a plurality of operations of ANS decoding on the binary sequence to obtain a symbol sequence, wherein an initial operation of the plurality of operations generates a first symbol using a first probability parameter derived from a target probabilistic shaping distribution, wherein the target probabilistic shaping distribution is a non-uniform probabilistic shaping distribution, and wherein a second operation of the plurality of operations generates a second symbol using a second probability parameter derived from the target probabilistic shaping distribution and the first symbol; and transmitting the symbol sequence.
Clause 16: The method of Clause 15, wherein the first probability parameter includes a first frequency parameter and a first cumulative parameter, wherein the first frequency parameter indicates a first set of frequencies of occurrence corresponding to each symbol of the symbol sequence according to the target probabilistic shaping distribution, and wherein the first cumulative parameter indicates a sum of the first set of frequencies of occurrence.
Clause 17: The method of Clause 16, wherein the second probability parameter includes a second frequency parameter and a second cumulative parameter, wherein the second frequency parameter indicates a second set of frequencies of occurrence corresponding to remaining symbols, of the symbol sequence, other than the first symbol.
Clause 18: The method of Clause 17, wherein the second cumulative parameter indicates a sum of the second set of frequencies of occurrence.
Clause 19: The method of any one of Clauses 15-18, wherein the symbol sequence has a plurality of possible symbol values, wherein transmitting the symbol sequence comprises transmitting the symbol sequence prior to performing all operations of the plurality of operations in accordance with remaining symbols of the symbol sequence only a single possible symbol value of the plurality of possible symbol values.
Clause 20: The method of any one of Clauses 15-19, further comprising: generating a state parameter using the binary sequence, wherein the plurality of operations are based on the state parameter.
Clause 21: The method of any one of Clauses 15-20, wherein performing the plurality of operations comprises performing the initial operation, the initial operation comprising: identifying the first symbol; updating a probability parameter, based on the first symbol, to obtain the first probability parameter; and updating a state parameter according to the first symbol and the first probability parameter.
Clause 22: One or more apparatuses, comprising: one or more memories comprising executable instructions; and one or more processors configured to execute the executable instructions and cause the one or more apparatuses to perform a method in accordance with any one of Clauses 1-21.
Clause 23: One or more apparatuses configured for wireless communications, comprising: one or more memories; and one or more processors, coupled to the one or more memories, configured to cause the one or more apparatuses to perform a method in accordance with any one of Clauses 1-21.
Clause 24: One or more apparatuses configured for wireless communications, comprising: one or more memories; and one or more processors, coupled to the one or more memories, configured to perform a method in accordance with any one of Clauses 1-21.
Clause 25: One or more apparatuses, comprising means for performing a method in accordance with any one of Clauses 1-21.
Clause 26: One or more non-transitory computer-readable media comprising executable instructions that, when executed by one or more processors of one or more apparatuses, cause the one or more apparatuses to perform a method in accordance with any one of Clauses 1-21.
Clause 27: One or more computer program products embodied on one or more computer-readable storage media comprising code for performing a method in accordance with any one of Clauses 1-21.
Clause 28: One or more apparatuses configured for wireless communications, comprising: a processing system that includes one or more processors and one or more memories coupled with the one or more processors, the processing system configured to cause the one or more apparatuses to perform a method in accordance with any one of Clauses 1-21.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system, the processing system comprising one or more memories and one or more processors coupled to the one or more memories, the processing configured to case a receiver to:
receive a communication;
decode the communication to obtain a symbol sequence that is associated with a non-uniform probabilistic shaping distribution;
perform a plurality of operations of asymmetric numeral system (ANS) encoding on a reverse symbol sequence derived from the symbol sequence, wherein a first operation of the plurality of operations uses a first probability parameter and a first symbol of the reverse symbol sequence, and wherein a second operation of the plurality of operations uses a second probability parameter and a second symbol of the reverse symbol sequence that occurs after the first symbol of the reverse symbol sequence; and
obtain a binary sequence in accordance with the ANS encoding.

2. The apparatus of claim 1, wherein the second probability parameter is based on one or more symbols that precede the second symbol in the reverse symbol sequence.

3. The apparatus of claim 2, wherein the one or more symbols include the first symbol.

4. The apparatus of claim 2, wherein the one or more symbols include every symbol, of the reverse symbol sequence, that precedes the second symbol.

5. The apparatus of claim 2, wherein the second probability parameter is further based on the second symbol.

6. The apparatus of claim 1, wherein the second probability parameter includes a frequency parameter and a cumulative parameter.

7. The apparatus of claim 6, wherein the frequency parameter indicates one or more frequencies of occurrence of one or more symbols that precede the second symbol in the reverse symbol sequence.

8. The apparatus of claim 7, wherein the cumulative parameter indicates a sum of the one or more frequencies of occurrence of the one or more symbols that precede the second symbol in the reverse symbol sequence.

9. The apparatus of claim 1, wherein to cause the receiver to perform the plurality of operations of ANS encoding, the processing system is configured to cause the receiver to update a corresponding probability parameter in each operation of the plurality of operations.

10. The apparatus of claim 1, wherein the symbol sequence includes a plurality of symbols in a first order from a lowest symbol index to a highest symbol index, and wherein the reverse symbol sequence includes the plurality of symbols in a second order from the highest symbol index to the lowest symbol index.

11. The apparatus of claim 1, wherein the binary sequence is associated with a uniform probabilistic distribution.

12. The apparatus of claim 1, wherein to cause the receiver to perform the plurality of operations, the processing system is configured to cause the receiver to perform the first operation, the first operation comprising:
identifying the first symbol;
updating a probability parameter, based on the first symbol, to obtain the first probability parameter; and
updating a state parameter according to the first symbol and the first probability parameter.

13. The apparatus of claim 12, wherein to cause the receiver to obtain the binary sequence, the processing system is configured to cause the receiver to obtain the binary sequence based on the state parameter.

14. The apparatus of claim 12, wherein the updating the state parameter is based on whether integer values of a probability mass function associated with the probability parameter include a greatest common divisor greater than 1.

15. The apparatus of claim 1, wherein decoding the communication is based on the non-uniform probabilistic shaping distribution.

16. An apparatus comprising a processing system, the processing system comprising one or more memories and one or more processors coupled to the one or more memories, the processing configured to case a transmitter to:
obtain a binary sequence;
perform a plurality of operations of asymmetric numeral system (ANS) decoding on the binary sequence to obtain a symbol sequence, wherein an initial operation of the plurality of operations generates a first symbol using a first probability parameter derived from a target probabilistic shaping distribution, wherein the target probabilistic shaping distribution is a non-uniform probabilistic shaping distribution, and wherein a second operation of the plurality of operations generates a second symbol using a second probability parameter derived from the target probabilistic shaping distribution and the first symbol; and
transmit the symbol sequence.

17. The apparatus of claim 16, wherein the first probability parameter includes a first frequency parameter and a first cumulative parameter, wherein the first frequency parameter indicates a first set of frequencies of occurrence corresponding to each symbol of the symbol sequence according to the target probabilistic shaping distribution, and wherein the first cumulative parameter indicates a sum of the first set of frequencies of occurrence.

18. The apparatus of claim 17, wherein the second probability parameter includes a second frequency parameter and a second cumulative parameter, wherein the second frequency parameter indicates a second set of frequencies of occurrence corresponding to remaining symbols, of the symbol sequence, other than the first symbol.

19. The apparatus of claim 18, wherein the second cumulative parameter indicates a sum of the second set of frequencies of occurrence.

20. The apparatus of claim 16, wherein the symbol sequence has a plurality of possible symbol values, wherein to cause the transmitter to transmit the symbol sequence, the processing system is configured to cause the transmitter to transmit the symbol sequence prior to performing all operations of the plurality of operations in accordance with remaining symbols of the symbol sequence only a single possible symbol value of the plurality of possible symbol values.

21. The apparatus of claim 16, wherein the processing system is configured to cause the transmitter to:
generate a state parameter using the binary sequence, wherein the plurality of operations are based on the state parameter.

22. The apparatus of claim 16, wherein to cause the transmitter to perform the plurality of operations, the processing system is configured to cause the transmitter to perform the initial operation, the initial operation comprising:
identifying the first symbol;
updating a probability parameter, based on the first symbol, to obtain the first probability parameter; and
updating a state parameter according to the first symbol and the first probability parameter.

23. A method of wireless communication by a receiver, comprising:
receiving a communication;
decoding the communication to obtain a symbol sequence that is associated with a non-uniform probabilistic shaping distribution;
performing a plurality of operations of asymmetric numeral system (ANS) encoding on a reverse symbol sequence derived from the symbol sequence, wherein a first operation of the plurality of operations uses a first probability parameter and a first symbol of the reverse symbol sequence, and wherein a second operation of the plurality of operations uses a second probability parameter and a second symbol of the reverse symbol sequence that occurs after the first symbol of the reverse symbol sequence; and
obtaining a binary sequence in accordance with the ANS encoding.

24. A method of wireless communication at a transmitter, comprising:
obtaining a binary sequence;
performing a plurality of operations of asymmetric numeral system (ANS) decoding on the binary sequence to obtain a symbol sequence, wherein an initial operation of the plurality of operations generates a first symbol using a first probability parameter derived from a target probabilistic shaping distribution, wherein the target probabilistic shaping distribution is a non-uniform probabilistic shaping distribution, and wherein a second operation of the plurality of operations generates a second symbol using a second probability parameter derived from the target probabilistic shaping distribution and the first symbol; and
transmitting the symbol sequence.
